(19) United States
(12) Patent Application Publication
(10) Pub. No.: US 2025/0376772 A1
(43) Pub. Date: Dec. 11, 2025

(54) PROTON-CONDUCTING SOLID OXIDE ELECTROLYZERS, RELATED ELECTRODES AND METHODS FOR PRODUCING HYDROGEN GAS

(71) Applicant: Battelle Energy Alliance, LLC, Idaho Falls, ID (US)

(72) Inventors: Dong Ding, Idaho Falls, ID (US); Weilin Zhang, Murray, UT (US); Qian Zhang, Austin, TX (US)

(21) Appl. No.: 19/229,037

(22) Filed: Jun. 5, 2025

Related U.S. Application Data
(60) Provisional application No. 63/656,530, filed on Jun. 5, 2024.

(51) Int. Cl. C25B 11/047; C25B 1/042; C25B 9/19; C25B 13/02; C25B 13/07

(52) U.S. Cl. CPC C25B 11/047; C25B 1/042; C25B 9/19; C25B 13/02; C25B 13/07

(57) ABSTRACT

A proton-conducting solid oxide electrolyzer includes a first electrode configured to produce oxygen gas from steam, a second electrode configured to produce hydrogen gas from the steam, and a proton-conducting solid oxide electrolyte between the first electrode and the second electrode. The first electrode includes barium zirconate of formula BaZrO_{3-δ} doped with at least one transition metal and substantially free of a rare earth element, wherein δ is an oxygen deficit, and wherein the at least one transition metal comprises cobalt. Also disclosed are an electrode for the proton-conducting solid oxide electrolyzer, and a method of producing hydrogen gas.

### CROSS-REFERENCE TO RELATED APPLICATIONS

This application claims the benefit under 35 U.S.C. § 119(e) of U.S. Provisional Patent Application Ser. No. 63/656,530, filed Jun. 5, 2024, the disclosure of which is hereby incorporated herein in its entirety by this reference.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

This disclosure relates generally to proton-conducting solid oxide electrolyzers, related electrodes and methods for production of hydrogen gas. In particular, embodiments of the disclosure relate to proton-conducting solid oxide electrolyzers for the production of hydrogen gas.

### BACKGROUND

Growing energy consumption and environmental concerns have stimulated the energy industry to phase out conventional fossil fuels and put more efforts on clean energy sources. The potential renewable energy from wind and solar exceeds global energy consumption; however, it is not flexible due to the intermittent nature of wind and sunlight. Thus, robust, cost-effective, and secure technologies are required to efficiently store this renewable energy.

An electrolyzer is an electrochemical device that enables the production of hydrogen gas from water. When powered by renewable energy, the electrolyzer produces hydrogen gas that is a clean and effective energy carrier to store renewable and sustainable energies. Therefore, electrolyzers has been used to store excess electricity from intermittent renewable sources (e.g., solar and wind) by converting the energy into hydrogen gas, which later can be efficiently converted to electricity through fuel cell technology.

Furthermore, the hydrogen gas generated from the electrolyzer is a cleaner-burning fuel that produces only water vapor when combusted, while conventional fuels (e.g., natural gas, petroleum) release greenhouse gases (e.g., carbon dioxide, methane) when combusted. The hydrogen fuel produced by electrolyzers has been used in fuel cell vehicles, industrial processes (e.g., ammonia production, methanol production), steel and cement manufacturing, and even for blending into natural gas pipelines. In addition, the ability to produce hydrogen gas on-site by the electrolyzer reduces the need for expensive and potentially dangerous transportation of conventional fuels, as well as decreases the financial strain from the costly and fluctuating prices of conventional fuels.

Oxygen-ion conducting solid-oxide electrolyzers have been used for the production of hydrogen gas. However, they are typically operated at temperatures above 700° C., thereby suffering from material degradation and material incompatibilities at such high operating temperatures.

### BRIEF SUMMARY

In a first aspect, a proton-conducting solid oxide electrolyzer is disclosed. The proton-conducting solid oxide electrolyzer includes a first electrode configured to produce oxygen gas from steam, a second electrode configured to produce hydrogen gas from the steam, and a proton-conducting solid oxide electrolyte between the first electrode and the second electrode. The first electrode includes barium zirconate of formula BaZrO_{3-δ} doped with at least one transition metal and substantially free of a rare earth element, wherein δ is an oxygen deficit, and wherein the at least one transition metal comprises cobalt.

In a second aspect, an electrode for a proton-conducting solid oxide electrolyzer is disclosed. The electrode comprises barium zirconate of formula BaZrO_{3-δ} doped with at least one transition metal and substantially free of a rare earth element, wherein δ is an oxygen deficit, and wherein the at least one transition metal comprises cobalt (Co), iron (Fe), nickel (Ni), copper (Cu), zinc (Zn), manganese (Mn), chromium (Cr), Nd, or any combination thereof.

In a third aspect, a method of producing hydrogen gas is disclosed. The method includes introducing steam into a proton-conducting solid oxide electrolyzer. The proton-conducting solid oxide electrolyzer comprises a first electrode formulated to produce oxygen gas from the steam, a second electrode formulated to produce hydrogen gas from the steam, and a proton-conducting solid oxide electrolyte between the first electrode and the second electrode. The first electrode comprises barium zirconate of formula BaZrO_{3-δ} doped with at least one transition metal and substantially free of a rare earth element, wherein δ is an oxygen deficit, and wherein the at least one transition metal comprises cobalt. The method further includes applying a potential difference between the first electrode and the second electrode of the proton-conducting solid oxide electrolyzer to produce the hydrogen gas from the steam.

### BRIEF DESCRIPTION OF THE DRAWINGS

FIG. 1 is a simplified schematic view of a proton-conducting solid oxide electrolyzer and a system for producing hydrogen gas including the proton-conducting solid oxide electrolyzer therein, in accordance with embodiments of the disclosure;

FIG. 2 is a graphical result showing the effect of the different electrode materials of the proton-conducting solid oxide electrochemical cells on generated peak power density at different temperatures;

FIG. 3 shows the in situ FTIR spectra of cobalt- and zinc-doped barium zirconate (BCZZ) powder at a temperature of 600° C. when switching the gas atmosphere from 3% H₂O in air to 3% D₂O with air;

FIG. 4 is a graphical result showing the polarization resistances (Rₚ) of a symmetrical cell as a function of temperature at different steam concentrations;

FIG. 5 is a graphical result showing the effect of electrical bias on the polarization resistances (Rₚ) of the symmetrical cell in an electrolysis mode and a fuel cell mode;

FIG. 6 is a graphical result showing the Faraday efficiency as a function of the current density applied to the proton-conducting solid oxide electrolyzer at an operating temperature of about 600° C. and at different steam concentrations;

FIG. 7 is a graphical result showing the Faraday efficiency as a function of the cell voltage applied to the proton-conducting solid oxide electrolyzer at an operating temperature of about 600° C. and at different steam concentrations;

FIG. 8 is a graphical result showing the Faraday efficiency of the proton-conducting solid oxide electrolyzer as a function of current density at different operating temperatures;

FIG. 9 is a graphical result showing the Faraday efficiency of the proton-conducting solid oxide electrolyzer as a function of the cell voltage applied to the proton-conducting solid oxide electrolyzer at different operating temperatures and;

FIG. 10 is graphical result showing the Faraday efficiency of the proton-conducting solid oxide electrolyzer as a function of electrolysis current density applied to the proton-conducting solid oxide electrolyzer;

FIG. 11 is graphical result showing the Faraday efficiency of the proton-conducting solid oxide electrolyzer as a function of cell voltage applied to the proton-conducting solid oxide electrolyzer at different operating temperatures;

FIG. 12 is graphical result showing the Faraday efficiency of the proton-conducting solid oxide electrolyzer as a function of cell voltage applied to the proton-conducting solid oxide electrolyzer at different operating temperatures, and at different thickness of the proton-conducting solid oxide electrolyte; and

FIG. 13 is a graphical result showing the energy efficiency as a function of the hydrogen production rate of the proton-conducting solid oxide electrolyzer as a function of electrolyte thickness and operating temperature.

### DETAILED DESCRIPTION

Proton-conducting solid oxide electrolyzers of the disclosure allow for an enhanced Faraday efficiency of hydrogen gas production, an increased service life, and a relatively less costly and simpler operation compared to conventional electrolyzers (e.g., an oxygen-ion conducting solid-oxide electrolyzer). The proton-conducting solid oxide electrolyzer utilizes an electrode (e.g., an anode) that is formed of and includes barium zirconate having the chemical formula BaZrO_{3-δ} doped with at least one transition metal, wherein δ is an oxygen deficit.

The following description provides specific details, such as material compositions, device and/or system configurations, and operating conditions (e.g., temperatures) in order to provide a thorough description of embodiments of the disclosure. However, a person of ordinary skill in the art will understand that the embodiments of the disclosure may be practiced without necessarily employing these specific details. Indeed, the embodiments of the disclosure may be practiced in conjunction with conventional systems and methods employed in the industry. In addition, only those process components and acts necessary to understand the embodiments of the disclosure are described in detail below. A person of ordinary skill in the art will understand that some process components (e.g., temperature detectors) are inherently disclosed herein and that adding various conventional process components and acts would be in accord with the disclosure.

Further, the illustrations presented herein are not actual views of any proton-conducting solid oxide electrolyzer, or any component thereof, but are merely idealized representations, which are employed to describe embodiments of the disclosure.

As used herein, the singular forms following “a,” “an,” and “the” are intended to include the plural forms as well, unless the context clearly indicates otherwise.

As used herein, “and/or” includes any and all combinations of one or more of the associated listed items.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, any relational term, such as “first,” “second,” “top,” “bottom,” “upper,” “lower,” “above,” “beneath,” “side,” “upward,” “downward,” etc., is used for clarity and convenience in understanding the disclosure and accompanying drawings, and does not connote or depend on any specific preference or order, except where the context clearly indicates otherwise. For example, these terms may refer to an orientation of elements of any proton-conducting solid oxide electrolyzers when utilized in a conventional manner. Furthermore, these terms may refer to an orientation of elements of any proton-conducting solid oxide electrolyzers as illustrated in the drawings.

As used herein, the term “configured” refers to a size, shape, material composition, material distribution, orientation, and arrangement of one or more of at least one structure and at least one apparatus facilitating operation of one or more of the structure and the apparatus in a pre-determined way.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” in reference to a numerical value for a particular parameter is inclusive of the numerical value and a degree of variance from the numerical value that one of ordinary skill in the art would understand is within acceptable tolerances for the particular parameter. For example, “about” or “approximately” in reference to a numerical value may include additional numerical values within a range of from 90.0 percent to 108.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value. As used herein, the term “compatible” means that a material does not undesirably react, decompose, or absorb another material, and also that the material does not undesirably impair the chemical and/or mechanical properties of the another material.

As used herein, the term “proton-conducting solid oxide electrolyzer” means and includes an electrochemical cell that converts water (e.g., steam) to hydrogen gas, and utilizes a proton-conducting solid oxide as a proton conductor between an anode and a cathode of the electrochemical cell.

As used herein, the term “Faraday efficiency” refers to an efficiency that an electrical current applied to the proton-conducting solid oxide electrolyzer is utilized to produce hydrogen gas. The Faraday efficiency is expressed as a fraction or a percentage, and is calculated as the actual amount (moles) of hydrogen gas produced from the proton-conducting solid oxide electrolyzer divided by the theoretical amount (moles) of hydrogen gas that could be produced from the total charge passed through the proton-conducting solid oxide electrolyzer.

As used herein, the term “rare earth element” includes one or more of lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), scandium (Sc), and yttrium (Y).

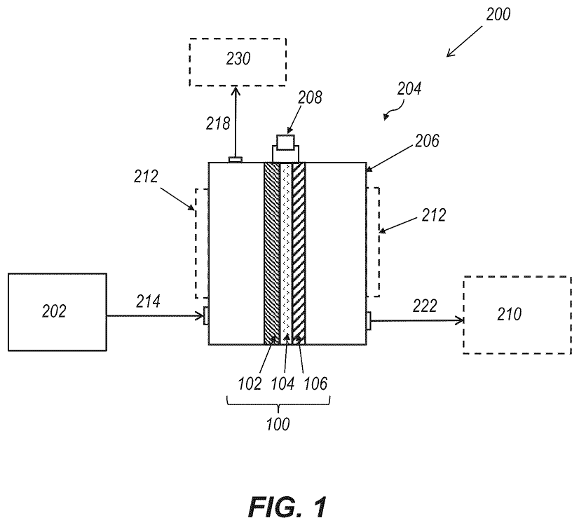

FIG. 1 is a simplified schematic view of a proton-conducting solid oxide electrolyzer 100 and a system 200 for producing hydrogen gas including the proton-conducting solid oxide electrolyzer 100 therein, in accordance with embodiments of the disclosure.

A proton-conducting solid oxide electrolyzer 100 includes a first electrode 102 formulated to produce oxygen gas from steam, a second electrode 106 electrode formulated to produce hydrogen (H₂) gas from the steam, and a proton-conducting solid oxide electrolyte 104 between the first electrode 102 and the second electrode 106.

The first electrode 102 of the proton-conducting solid oxide electrolyzer 100 comprises a barium zirconate of formula BaZrO_{3-δ} doped with at least one transition metal and substantially free of any rare earth element, wherein δ is an oxygen deficit, and wherein the at least one transition metal comprises cobalt (Co).

In some embodiments, the barium zirconate of formula BaZrO_{3-δ} doped with the at least one transition metal comprises cobalt (Co), iron (Fe), nickel (Ni), copper (Cu), zinc (Zn), manganese (Mn), chromium (Cr), niobium (Nb), molybdenum (Mo), titanium (Ti), vanadium (V), or any combination thereof.

In some embodiments, the barium zirconate of formula BaZrO_{3-δ} doped with the at least one transition metal exhibits a perovskite structure.

In some embodiments, the at least one dopant transition metal of the barium zirconate of formula BaZrO_{3-δ} comprises cobalt (Co).

In some embodiments, the at least one dopant transition metal of the barium zirconate of formula BaZrO_{3-δ} comprises zinc (Zn).

In some embodiments, the at least one dopant transition metal of the barium zirconate of formula BaZrO_{3-δ} comprises cobalt, zinc, or a mixture thereof.

In some embodiments, the barium zirconate of formula BaZrO_{3-δ} doped with the at least one transition metal comprises a cobalt- and zinc-doped barium zirconate (BCZZ).

In some embodiments, the barium zirconate of formula BaZrO_{3-δ} doped with the at least one transition metal comprises BaCo_{0.8}Zr_{0.1}Zn_{0.1}O_{3-δ}, BaCo_{0.7}Zr_{0.2}Zn_{0.1}O_{3-δ}, BaCo_{0.7}Zr_{0.1}Zn_{0.2}O_{3-δ}, or any combination thereof, wherein δ is an oxygen deficit.

In some embodiments, the barium zirconate of formula BaZrO_{3-δ} doped with the at least one transition metal comprises BaCo_{0.8}Zr_{0.1}Zn_{0.1}O_{3-δ}.

In some embodiments, the first electrode 102 comprises a mixture of the barium zirconate of formula BaZrO_{3-δ} doped with the at least one transition metal and a yttrium- and ytterbium-doped barium-cerate-zirconate (BCZYYb).

In some embodiments, the first electrode 102 comprises a mixture of the barium zirconate of formula BaZrO_{3-δ} doped with the at least one transition metal and a yttrium- and ytterbium-doped barium-cerate-zirconate of formula BaCe_{0.7}Zr_{0.1}Y_{0.1}Yb_{0.1}O_{3-δ}.

The proton-conducting solid oxide electrolyte 104 of the proton-conducting solid oxide electrolyzer 100 may be formed of and include at least one electrolyte material compatible with the material compositions of the first electrode 102 and the second electrode 106 under the operating conditions (e.g., temperature, pressure, current density, etc.) of the proton-conducting solid oxide electrolyzer 100. The electrolyte material of the proton-conducting solid oxide electrolyte 104 may be formulated to remain substantially adhered (e.g., laminated) to the first electrode 102 and the second electrode 106 at relatively high current densities, such as at current densities greater than or equal to about 0.1 amperes per square centimeter (A/cm²) (e.g., greater than or equal to about 0.5 A/cm², greater than or equal to about 1.0 A/cm², greater than or equal to about 2.0 A/cm², greater than or equal to about 3.0 A/cm², greater than or equal to about 4.0 A/cm², etc.).

In some embodiments, the electrolyte material of the proton-conducting solid oxide electrolyte 104 comprises a perovskite having an ionic conductivity (e.g., H⁺ conductivity) greater than or equal to about 10⁻² S/cm (e.g., within a range of from about 1×10⁻² S/cm to about 1 S/cm) at one or more temperatures within a range of from about 400° C. to about 700° C.

By way of non-limiting example, the proton-conducting solid oxide electrolyte 104 may comprise a yttrium- and ytterbium-doped barium-cerate-zirconate (BCZYYb) such as BaCe_{y}Zr_{0.8-y}Y_{0.2-x}YbₓO_{3-δ}, wherein x and y are dopant levels and δ is the oxygen deficit (e.g., BaCe_{0.4}Zr_{0.4}Y_{0.1}Yb_{0.1}O_{3-δ}, BaCe_{0.5}Zr_{0.3}Y_{0.1}Yb_{0.1}O_{3-δ}, BaCe_{0.7}Zr_{0.1}Y_{0.1}Yb_{0.1}O_{3-δ}); a yttrium- and ytterbium-doped barium-strontium-niobate (BSNYYb) such as Ba₃(Sr₁₋ₓNb_{2-y}YₓYb_{y})O_{9-δ}, wherein x and y are dopant levels and δ is the oxygen deficit; a doped barium-cerate (BaCeO₃) (e.g., yttrium-doped BaCeO₃ (BCY)); a doped barium-zirconate (BaZrO₃) (e.g., yttrium-doped BaCeO₃ (BZY)); a barium-yttrium-stannate (Ba₂(YSn)O_{5.5}); a barium-calcium-niobate (Ba₃(CaNb₂)O₉); or any combination thereof. In some embodiments, the proton-conducting solid oxide electrolyte 104 comprises a BCZYYb. In some embodiments, the proton-conducting solid oxide electrolyte 104 comprises yttrium- and ytterbium-doped barium-cerate-zirconate of chemical formula BaCe_{0.7}Zr_{0.1}Y_{0.1}Yb_{0.1}O_{3-δ}.

The proton-conducting solid oxide electrolyte 104 of the proton-conducting solid oxide electrolyzer 100 may have a thickness of from about 6 microns (μm) to about 18 μm. In some embodiments, the proton-conducting solid oxide electrolyte 104 of the proton-conducting solid oxide electrolyzer 100 has a thickness of from about 6 microns (μm) to about 10 μm. In some embodiments, the proton-conducting solid oxide electrolyte 104 has a thickness of less than 10 microns.

The second electrode 106 of the proton-conducting solid oxide electrolyzer 100 may be formed of and include a material compatible with the material compositions of the first electrode 102 and the proton-conducting solid oxide electrolyte 104 under the operating conditions (e.g., temperature, pressure, current density, etc.) of the proton-conducting solid oxide electrolyzer 100.

By way of non-limiting examples, the second electrode 106 may comprise a cermet material including at least one metal (e.g., Ni) and at least one perovskite, such as a nickel/perovskite cermet (Ni-perovskite) material (e.g., a Ni—BCZYYb, such as Ni—BaCe_{0.4}Zr_{0.4}Y_{0.1}Yb_{0.1}O_{3-δ}, Ni—BaCe_{0.5}Zr_{0.3}Y_{0.1}Yb_{0.1}O_{3-δ}, or Ni—BaCe_{0.7}Zr_{0.1}Y_{0.1}Yb_{0.1}O_{3-δ}; a Ni—BSNYYb; Ni—BaCeO₃; Ni—BaZrO₃; Ni—Ba₂(YSn)O_{5.5}; Ni—Ba₃(CaNb₂)O₉). In some embodiments, the second electrode 106 comprises a Ni—BCZYYb. In some embodiments, the at least one perovskite of the cermet material the second electrode 106 comprises a yttrium- and ytterbium-doped barium-cerate-zirconate (BCZYYb), a yttrium- and ytterbium-doped barium-strontium-niobate (BSNYYb), a doped barium-zirconate, a doped barium-cerate, a doped barium zirconate-cerate, a barium-yttrium-stannate, a barium-calcium-niobate, or any combination thereof.

The first electrode 102, the second electrode 106, and the proton-conducting solid oxide electrolyte 104 may each individually exhibit any desired dimensions (e.g., length, width, thickness) and any desired shape (e.g., a cubic shape, cuboidal shape, a tubular shape, a tubular spiral shape, a spherical shape, a semi-spherical shape, a cylindrical shape, a semi-cylindrical shape, a conical shape, a triangular prismatic shape, a truncated version of one or more of the foregoing, and irregular shape). The dimensions and the shapes of the first electrode 102, the second electrode 106, and the proton-conducting solid oxide electrolyte 104 may be selected relative to one another such that the proton-conducting solid oxide electrolyte 104 substantially intervenes between opposing surfaces of the first electrode 102 and the second electrode 106.

The proton-conducting solid oxide electrolyzer 100 (including the first electrode 102, the proton-conducting solid oxide electrolyte 104, and the second electrode 106 thereof) may be formed using conventional processes (e.g., rolling processes, milling processes, shaping processes, pressing processes, consolidation processes, etc.). The proton-conducting solid oxide electrolyzer 100 may be mono-faced or bi-faced, and may have a prismatic, folded, wound, cylindrical, or jelly rolled configuration.

Still referring to FIG. 1, a system 200 for producing hydrogen gas includes the proton-conducting solid oxide electrolyzer 100, in accordance with embodiments of disclosure.

The system 200 includes at least one electrochemical apparatus 204 in fluid communication with a steam source 202. Although FIG. 1 depicts the system 200 as including a single (i.e., only one) electrochemical apparatus 204, the disclosure is not so limited and the system 200 may include any number of electrochemical apparatuses 204 therein. Put another way, the system 200 may include a single (e.g., only one) electrochemical apparatus 204, or may include multiple (e.g., more than one) electrochemical apparatuses 204. If the system 200 includes multiple electrochemical apparatuses 204, each of the electrochemical apparatuses 204 may be substantially the same (e.g., exhibit substantially the same components, component sizes, component shapes, component material compositions, component material distributions, component positions, component orientations, etc.) and may be operated under substantially the same conditions (e.g., substantially the same temperatures, pressures, flow rates, etc.), or at least one of the electrochemical apparatus 204 may be different (e.g., exhibit one or more of different components, different component sizes, different component shapes, different component material compositions, different component material distributions, different component positions, different component orientations, etc.) than at least one other of the electrochemical apparatuses 204 and/or may be operated under different conditions (e.g., different temperatures, different pressures, different flow rates, etc.) than at least one other of the electrochemical apparatuses 204. By way of non-limiting examples, one of the electrochemical apparatuses 204 may be configured for and operated under a different temperature (e.g., a different operating temperature resulting from a different material composition of one of more components of one or more proton-conducting solid oxide electrolyzers 100 thereof) than at least one other of the electrochemical apparatuses 204. In some embodiments, two or more electrochemical apparatuses 204 are provided in parallel with one another. In some embodiments, two or more electrochemical apparatuses 204 are provided in series with one another.

The electrochemical apparatus 204 includes a housing structure 206, and at least one proton-conducting solid oxide electrolyzer 100 contained within the housing structure 206. Although the electrochemical apparatus 204 is depicted as including a single (i.e., only one) proton-conducting solid oxide electrolyzer 100 in FIG. 1, the electrochemical apparatus 204 may include any number of proton-conducting solid oxide electrolyzers 100. Put another way, the electrochemical apparatus 204 may include a single (e.g., only one) proton-conducting solid oxide electrolyzer 100, or may include multiple (e.g., more than one) proton-conducting solid oxide electrolyzers 100. If the electrochemical apparatus 204 includes multiple proton-conducting solid oxide electrolyzers 100, each of the proton-conducting solid oxide electrolyzers 100 may be substantially the same (e.g., exhibit substantially the same components, component sizes, component shapes, component material compositions, component material distributions, component positions, component orientations, etc.) and may be operated under substantially the same conditions (e.g., substantially the same temperatures, pressures, flow rates, etc.), or at least one of the proton-conducting solid oxide electrolyzer 100 may be different (e.g., exhibit one or more of different components, different component sizes, different component shapes, different component material compositions, different component material distributions, different component positions, different component orientations, etc.) than at least one other of the proton-conducting solid oxide electrolyzer 100 and/or may be operated under different conditions (e.g., different temperatures, different pressures, different flow rates, etc.) than at least one other of the proton-conducting solid oxide electrolyzer 100. By way of non-limiting example, one of the proton-conducting solid oxide electrolyzers 100 may be configured for and operated at a different temperature (e.g., different operating temperature resulting from a different material composition of one of more components thereof) than at least one other of the proton-conducting solid oxide electrolyzer 100. In some embodiments, two or more proton-conducting solid oxide electrolyzers 100 are provided in parallel with one another within the housing structure 206 of the electrochemical apparatus 204.

The housing structure 206 is configured to receive and direct steam stream 214 to the first electrode 102 of the proton-conducting solid oxide electrolyzer 100. The housing structure 206 may also be configured to direct oxygen (O₂) gas produced at the first electrode 102 of the proton-conducting solid oxide electrolyzer 100 away from the electrochemical apparatus 204 as an O₂ gas stream 218. Furthermore, the housing structure 206 may optionally be configured to direct hydrogen (H₂) gas produced at the second electrode 106 of the proton-conducting solid oxide electrolyzer 100 away from the electrochemical apparatus 204 as an H₂ gas stream 222.

The system 200 also includes a power source 208 electrically connected (e.g., electrically coupled) to the proton-conducting solid oxide electrolyzer 100. The power source 208 may comprise one or more of a device, structure, and apparatus configured to apply a potential difference (e.g., voltage) between the first electrode 102 and the second electrode 106 of the proton-conducting solid oxide electrolyzer 100 to facilitate the electrolysis of water. The power source 208 may, for example, comprise one or more of a device, structure, or apparatus configured and operated to use one or more of solar energy, wind (e.g., wind turbine) energy, hydropower energy, geothermal energy, nuclear energy, combustion-based energy, and waste heat (e.g., heat generated from one or more of an engine, a chemical process, and a phase change process) to apply the potential difference between the first electrode 102 and the second electrode 106 of the proton-conducting solid oxide electrolyzer 100.

Still referring to FIG. 1, the system also includes at least one steam source 202 in fluid communication with the electrochemical apparatus 204. The steam source 202 comprises at least one apparatus configured and operated to produce a steam stream 214 (e.g., gaseous H₂O). By way of non-limiting example, the steam source 202 may comprise a boiler apparatus configured and operated to heat liquid H₂O to a temperature greater than or equal to about 100° C. In some embodiments, the steam source 202 is configured and operated to convert the liquid H₂O to steam having a temperature within a range of an operating temperature of the proton-conducting solid oxide electrolyzer 100 of the electrochemical apparatus 204, such as a temperature within a range of from about 400° C. to about 700° C. (e.g., from about 400° C. to about 600° C.). In additional embodiments, the steam source 202 is configured and operated to convert the liquid H₂O into steam having a temperature below the operating temperature of the proton-conducting solid oxide electrolyzer 100. In such additional embodiments, a heating apparatus 212 may be employed to provide additional heat to the steam stream 214 to the operating temperature of the proton-conducting solid oxide electrolyzer 100.

The steam stream 214 may be directed into the electrochemical apparatus 204 from the steam source 202 to interact with the first electrode 102 of the proton-conducting solid oxide electrolyzer 100. The potential difference applied between the first electrode 102 and the second electrode 106 permits the first electrode 102 to function as an anode and the second electrode 106 to function as a cathode to facilitate the production of H₂ gas from steam.

The system 200 may optionally include at least one heating apparatus 212 operatively associated with the electrochemical apparatus 204. The heating apparatus 212 may comprise at least one apparatus (e.g., one or more of a combustion heater, an electrical resistance heater, an inductive heater, and an electromagnetic heater) configured and operated to heat one or more of at least a portion of the electrochemical apparatus 204 and one or more of the steam streams 214 directed into the electrochemical apparatus 204 during the operation of the proton-conducting solid oxide electrolyzer 100 to an operating temperature of the electrochemical apparatus 204.

The operating temperature of the electrochemical apparatus 204 may at least partially depend on the material compositions of the first electrode 102, the proton-conducting solid oxide electrolyte 104, and the second electrode 106 thereof. In some embodiments, the heating apparatus 212 heats one or more of at least a portion of the electrochemical apparatus 204 and one or more of the streams directed into the electrochemical apparatus 204 to a temperature within a range of from about 400° C. to about 700° C. (e.g., from about 400° C. to about 600° C.). In additional embodiments, such as in embodiments where a temperature of the streams is already within the operating temperature range of the proton-conducting solid oxide electrolyzer 100 of the electrochemical apparatus 204, the heating apparatus 212 may be omitted (e.g., absent) from the system 200.

The system 200 may optionally include one or more of at least one H₂ gas containment vessel 210 in fluid communication with the electrochemical apparatus 204. The H₂ gas containment vessel 210 may be configured to receive and temporarily store (e.g., contain) one or more portions of the H₂ gas stream 222 exiting the electrochemical apparatus 204.

The system 200 may optionally include at least one O₂ gas containment vessel 230 in fluid communication with the electrochemical apparatus 204. The O₂ gas containment vessel 230 may be configured to receive and temporarily store (e.g., contain) one or more portions of the O₂ gas stream 218 exiting the electrochemical apparatus 204.

During operation of the system 200, the steam stream 214 is directed from the steam source 202 and into the electrochemical apparatus 204 to interact with the first electrode 102 of the proton-conducting solid oxide electrolyzer 100 contained therein. A potential difference (e.g., voltage) is applied between the first electrode 102 (serving as an anode) and the second electrode 106 (serving as a cathode) by the power source 208, so that oxidation of the steam stream 214 takes place at the first electrode 102 to generate O₂ gas, protons (H⁺), and electrons (e⁻) according to the following equation (1):

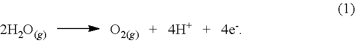

The generated O₂ gas may exit the electrochemical apparatus 204 as an O₂ gas stream 218. If the system 200 includes the O₂ gas containment vessel 230, the generated O₂ gas may be directed to the O₂ gas containment vessel 230 for storage.

The generated protons permeate (e.g., diffuse) across the proton-conducting solid oxide electrolyte 104 to the second electrode 106, while the generated electrons are directed to the power source 208 through external circuitry.

At the second electrode 106, the protons exiting the proton-conducting solid oxide electrolyte 104 reacts with the electrons received from the power source 208 to form H₂ gas, according to the following equation (2):

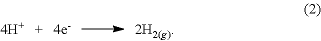

The generated H₂ gas may exit the electrochemical apparatus 204 as the H₂ gas stream 222. If the system 200 includes the H₂ gas containment vessel 210, the generated H₂ gas may be directed to the H₂ gas containment vessel 210 for storage.

The proton-conducting solid oxide electrolyzer 100 may be employed to achieve the hydrogen gas production at relatively lower temperatures, compared to conventional oxygen-ion conducting solid-oxide electrolyzers. The proton-conducting solid oxide electrolyzer 100 not only prolongs the service life of the electrolyzer, but also permits the use of cost-effective balance-of-plant components in the system. In addition, the proton-conducting solid oxide electrolyzer 100 can produce dry hydrogen gas, circumventing many problems otherwise associated with purifying humid hydrogen gas and/or undesirable steam-based metal oxidation.

The proton-conducting solid oxide electrolyzer 100 may be operated at a steam concentration of from about 3% to about 80% by volume (e.g., from about 10% to about 40% by volume), a current density of from about 0.1 A cm⁻² to about 5 A cm⁻² (e.g., from about 0.3 A cm⁻² to about 2.2 A cm⁻²), a cell voltage of from about 1.0 volts (V) to about 1.5 V (e.g., from about 1.05 to about 1.4 V), and at a temperature of from about 400° C. to about 700° C. In some embodiments, the proton-conducting solid oxide electrolyzer 100 is operated at a temperature of from about 500° C. to about 600° C.

Furthermore, the proton-conducting solid oxide electrolyzer 100 may provide a significant reduction in an energy loss during the production of hydrogen gas, especially at an operating temperature below 600° C. Therefore, the energy applied to the proton-conducting solid oxide electrolyzer 100 to drive the electrolysis of water may be effectively converted into hydrogen fuel. An effective electrolyzer must convert a high fraction of the energy (e.g., electricity current) into hydrogen gas. In some embodiments, the proton-conducting solid oxide electrolyzer 100 may achieve a current density of about 1.98 A cm⁻² or more at a cell voltage of about 1.3 V and an operation temperature of about 600° C. Furthermore, in some of such embodiments, the proton-conducting solid oxide electrolyzer 100 may exhibit a Faraday efficiency of hydrogen gas production of about 90% or more.

The proton-conducting solid oxide electrolyzer 100 provides an enhanced Faraday efficiency of hydrogen gas production, an increased service life, and a relatively less costly and simpler operation compared to conventional electrolyzers (e.g., an oxygen-ion conducting solid-oxide electrolyzer).

The following examples serve to explain embodiments of the disclosure in more detail. These examples are not to be construed as being exhaustive, exclusive, or otherwise limiting as to the scope of the disclosure.

### EXAMPLES

### Example 1

The electrode materials BaCo_{0.8}Zr_{0.1}Zn_{0.1}O_{3-δ} (BCZZ), BaCo_{0.7}Zr_{0.2}Zn_{0.1}O_{3-δ} (BCZZ721), and BaCo_{0.7}Zr_{0.1}Zn_{0.2}O_{3-δ} (BCZZ712) were synthesized by the sol-gel method. Typically, a stoichiometric amount of metal nitrates was dissolved in deionized water with ethylenediaminetetraacetic acid (EDTA) and citric acid. The molar ratio between the metal ions, EDTA, and citric acid was 1:1:1.5. Ammonium hydroxide was used to adjust the pH to about 9. After the evaporation of water, the gel was calcined at about 250° C. for about 10 hours. The primary powder was then ground and calcined at about 600° C. for about 5 hours, followed by a final calcination at about 1000° C. for about 2 hours. About 10 grams of the electrode materials (in powder form) was synthesized in each batch synthesis. The electrode powder was then ball milled at about 400 rpm for about 10 hours (30 minutes milling with 10 minutes break for each cycle) to reduce the particle size for ink preparation.

### Example 2

The electrolyte material BaZr_{0.1}Ce_{0.7}Y_{0.1}Yb_{0.1}O_{3-δ} (BZCYYb1711) and BaZr_{0.4}Ce_{0.4}Y_{0.1}Yb_{0.1}O_{3-δ} (BZCYYb4411) were synthesized by the solid-state reaction method. A stoichiometric amount of BaCO₃, ZrO₂, CeO₂, Y₂O₃, and Yb₂O₃ were mixed thoroughly in ethanol using YSZ milling media. The mixture was then dried on a hot plate to evaporate the ethanol. The well-mixed powders were then pressed into large pellets, followed by multiple calcinations at a temperature of about 1100° C. for about 10 hours, and ball-milling steps until the desired phase was obtained. About 120 grams of the electrolyte powder was synthesized in each batch.

### Example 3

To fabricate symmetrical cells, BZCYYb1711 powder was mixed with 1 wt % PVB and 1 wt % NiO and then dry pressed and sintered at a temperature of about 1450° C. for about 5 hours. The electrode ink obtained from EXAMPLE 1 was brush painted on both sides of the electrolyte followed by firing at a temperature of about 950° C. for about 2 hours. The effective area of the symmetrical cells was 0.178 cm². For the three-electrode measurement, a small area of silver paste was brush-painted near the BCZZ working electrode as the reference electrode. Three silver wires were used to connect the working electrode, counter electrode, and reference electrode to the electrochemical working station.

To fabricate single cells, Ni—BZCYYb1711 or Ni—BZCYYb4411 half cells were prepared by tape casting and sintering at a temperature of about 1450° C. for about 5 hours. The electrode ink of EXAMPLE 1 was brush painted onto the electrolyte and fired at a temperature of about 1000° C. for about 2 hours. Both 10-mm and 1-inch single cells were fabricated, and the effective area were 0.178 and 1.26 cm², respectively.

### Example 4

For the electrochemical measurements of the symmetrical cell, two pieces of silver mesh were used as the current collectors. Impedance spectra were acquired using Solartron 1400 with an AC amplitude of about 10 mV in the frequency range from about 100 kHz to about 0.01 Hz. All the single cells were mounted on alumina supporting tubes and sealed with glass sealant GM31107 (SCHOTT). For the 10-mm single cell measurement in fuel cell mode, 20 seem dry H₂ was used as the fuel and ambient air was used as the oxidant. For the 1-inch single cell measurement in the fuel cell mode, 40 seem dry H₂ was used as the fuel and 400 seem air was used as the oxidant. The glass seal provided reliable sealing, maintaining an outlet hydrogen gas flow rate of 40 seem under the open circuit voltage (OCV) condition. In contrast, the ceramabond sealing typically resulted in about 2 seem hydrogen leakage.

For the 1-inch single cell measurement in the electrolysis mode, 40 seem dry H₂ was fed to the H₂ electrode, and 100 seem air with 30 vol % H₂O was fed to the oxygen electrode. For the electrolysis measurement under different concentrations of steam (10 vol %, 20 vol %, and 40 vol %), the total air flow rate was adjusted accordingly to make sure he steam flow rate was constant. The cell performance and stability were monitored by Solartron 1400.

### Example 5

The Faradaic efficiency was measured by a new flow rate method, which can directly monitor the H₂ production rate at different operating conditions. The uncertainty in the flow rate method for determining FE is primarily quantified based on the accuracy of the mass flow meter and the cell's effective area. For example, in a cell with a 1.267 cm² effective area and an electrolysis current density of 0.3 A cm⁻², the electrolysis current is 0.380 A, corresponding to a theoretical H₂ production rate of 2.89 seem at 100% FE. Given the flow meter's measurement uncertainty of 0.01 sccm, the resulting uncertainty in H₂ production rate is 0.35%. To further improve the measurement accuracy, the average H₂ flow rate for at least 3 minutes was used as the actual flow rate. The 1-inch cells with an effective area of 1.26 cm² (a=1.26 cm²) were used to measure the FE to reduce the measurement uncertainty. To further improve the measurement accuracy, the average H₂ flow rate for at least 3 minutes was used as the actual flow rate. After the cell was fully reduced in H₂, the exhaust flow rate (from the H₂ electrode side) was measured by a flow meter (Alicat). The exhaust flow rate x at the open circuit voltage (OCV) condition should be close to 40 seem to ensure a negligible gas leakage from the testing fixture, sealant and the cell. Then, under the electrolysis condition with an electrolysis current density of I, the exhaust H₂ flow rate increased to y. The difference of the exhaust H₂ flow rate (y−x) was the H₂ production rate from water electrolysis. The actual H₂ production rate can be calculated as

$${n}_{act} = \frac{P ( y - x )}{RT} ,$$

where P is the pressure of the gas, R is the gas constant, T is the temperature of the gas. The theoretical H₂ production rate can be calculated as

$${n}_{th} = \frac{I \times a}{2 F} ,$$

where F is the Faraday constant. The FE can be further calculated as

$$FE = \frac{{n}_{act}}{{n}_{th}} \times 100 \% .$$

### Example 6

To investigate the effect of electrode material on the electrochemical performance of the proton-conducting solid oxide electrolyzer, the proton-conducting solid oxide electrochemical cell (P-SOEC) used in the study included an electrode configured to produce oxygen gas from steam (“an anode”) containing tested electrode material, an electrode configured to produce hydrogen gas from the steam (“a cathode”) containing Ni—BaCe_{0.7}Zr_{0.1}Y_{0.1}Yb_{0.1}O₃, and a proton-conducting solid oxide electrolyte containing BaZr_{0.1}Ce_{0.7}Y_{0.1}Yb_{0.1}O_{3-δ} as the electrolyte at a thickness of 10 μm. The electrode materials tested in the study for the anode were: BCZZ #1 (BaCo_{0.8}Zr_{0.1}Zn_{0.1}O_{3-δ}), BPHYC (Ba_{0.9}Pr_{0.1}Hf_{0.1}Y_{0.1}Co_{0.8}O_{3-δ}), BSCF (Ba_{0.5}Sr_{0.5}Co_{0.8}Fe_{0.2}O_{3-δ}), D-BFZ (Ba_{0.875}Fe_{0.875}Zr_{0.125}O_{3-δ}), PBSCF (PrBa_{0.5}Sr_{0.5}Co_{1.5}Fe_{0.5}O_{5+δ}), BCCY (BaCo_{0.7}(Ce_{0.8}Y_{0.2})_{0.3}O_{3-δ}), BCFZY (BaCo_{0.4}Fe_{0.4}Zr_{0.1}Y_{0.1}O_{3-δ}), and PNC (PrNi_{0.5}Co_{0.5}O_{3-δ}).

The proton-conducting solid oxide electrochemical cells (P-SOECs) were tested in a fuel cell mode using hydrogen (H₂) gas as a fuel and ambient air as an oxidant at three different operating temperatures: 500° C., 550° C., and 600° C.

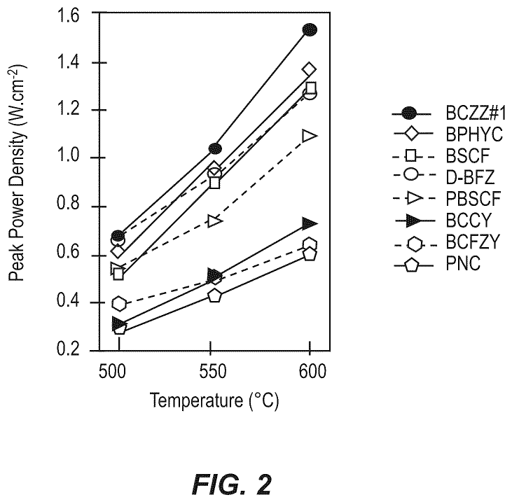

FIG. 2 is a graphical result showing the effect of different electrode materials of the anode of the P-SOEC on the generated peak power density at different operating temperatures. As shown in FIG. 2, at the same cell configuration and operating conditions, the P-SOEC utilizing the anode containing BCZZ #1 demonstrated the highest peak power density compared to the P-SOECs using other electrode materials, at all tested temperatures.

BCZZ #1 was a barium zirconate of formula BaZrO_{3-δ} doped with cobalt (Co) and zinc (Zn) having a formula BaCo_{0.8}Zr_{0.1}Zn_{0.1}O_{3-δ}. The P-SOEC utilizing the anode comprising BCZZ #1 showed the highest performance with a peak power density of about 1.55 W·cm⁻² when the P-SOEC was operated in a fuel cell mode at an operation temperature of about 600° C. using H₂ gas as a fuel and an ambient air as an oxidant.

Moreover, three barium zirconate BaZrO_{3-δ} doped with cobalt (Co) and Zinc (Zn) (also referred herein as “BCZZ”) materials at different stoichiometries were studied as the electrode material of the anode of the P-SOEC: BCZZ #1 (BaCo_{0.8}Zr_{0.1}Zn_{0.1}O_{3-δ}), BCZZ #2 (BaCo_{0.7}Zr_{0.2}Zn_{0.1}O_{3-δ}), and BCZZ #3 (BaCo_{0.7}Zr_{0.1}Zn_{0.2}O_{3-δ}). The three BCZZ materials were synthesized via the sol-gel method, and characterized using an X-ray diffraction (XRD) spectroscopy. The XRD patterns showed that BCZZ #1 (BaCo_{0.8}Zr_{0.1}Zn_{0.1}O_{3-δ}) and BCZZ #3 (BaCo_{0.7}Zr_{0.1}Zn_{0.2}O_{3-δ}) each exhibited a pure phase of perovskite structure, while BCZZ #2 (BaCo_{0.7}Zr_{0.2}Zn_{0.1}O_{3-δ}) exhibited perovskite structure with a minor secondary phase.

The BCZZ #1 (BaCo_{0.8}Zr_{0.1}Zn_{0.1}O_{3-δ}) was further characterized using a transmission electron (TEM) microscopy and an energy-dispersive X-ray (EDS) spectroscopy. Both characterization results further confirmed the cubic perovskite structure and uniform distribution of all elements in BCZZ #1 (BaCo_{0.8}Zr_{0.1}Zn_{0.1}O_{3-δ}).

The electrochemical performance of the P-SOECs utilizing an electrode configured to produce oxygen gas from steam (“an anode”) containing tested BCZZ electrode material (BCZZ #1, BCZZ #2, or BCZZ #3), an electrode configured to produce hydrogen gas from the steam (“a cathode”) containing Ni—BaCe_{0.7}Zr_{0.1}Y_{0.1}Yb_{0.1}O₃, and BaZr_{0.1}Ce_{0.7}Y_{0.1}Yb_{0.1}O_{3-δ} as a proton-conducting solid oxide electrolyte at a thickness of 10 μm, were used in the study. The electrochemical performance of the P-SOECs was determined in the fuel cell mode at an operating temperature of about 600° C. using hydrogen as the fuel and ambient air as the oxidant. Among the three BCZZ electrode materials, the BCZZ #1 (BaCo_{0.8}Zr_{0.1}Zn_{0.1}O_{3-δ}) provided the P-SOEC with the highest performance at a peak power density of about 1.55 W·cm⁻².

### Example 7

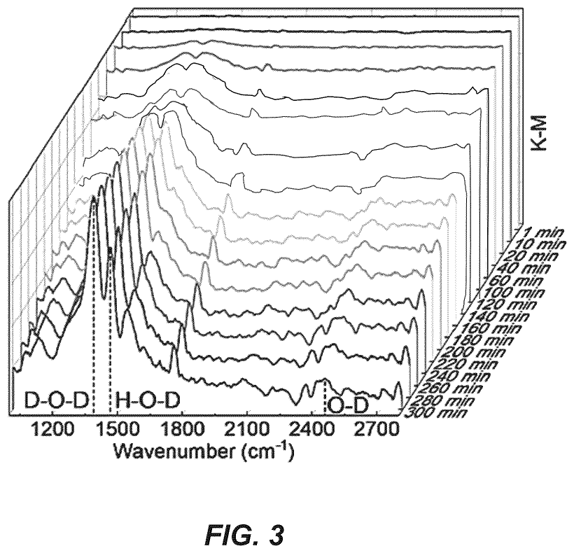

To examine the hydration property and the proton transport property of BCZZ #1, BaCo_{0.8}Zr_{0.1}Zn_{0.1}O_{3-δ} powder was studied using an in situ Fourier-transform infrared (FTIR) spectroscopy at a temperature of 600° C. when switching the gas atmosphere from 3% by volume H₂O in air to 3% by volume D₂O with air. FIG. 3 shows the FTIR spectra of BCZZ #1 powder at different time intervals from about 1 minute to about 300 minutes. The FTIR spectroscopy was used to observe the chemisorbed water concentration on the surface of the BCZZ #1 powder during an isotope exchange process. To verify proton mobility, heavy water (deuterium oxide, D₂O) was used in the isotope exchange experiment to evaluate the hydrogen/deuterium (H/D) ion interdiffusion.

As shown in FIG. 3, the broad peak at a wavelength range of from about 1200 cm⁻¹ to about 1700 cm⁻¹ attributed to H₂O/HDO/D₂O bending vibration. Both HDO and D₂O signals were relating to the chemisorbed OD_{O}⁻, which proved the isotope exchange in BCZZ #1 lattice. These spectra showed that the peak intensities of H—O-D and D-O-D increased over time and reached a plateau after 260 minutes, indicating the completion of the isotope exchange.

### Example 8

To evaluate the electrochemical activity, the polarization resistances (Rₚ) were measured for the proton-conducting solid oxide electrolyzer when different concentrations of the steam were fed into the proton-conducting solid oxide electrolyzer. The proton-conducting solid oxide electrolyzer used in the study was a symmetrical cell utilizing BCZZ #1-containing electrodes and a BZCYYb (BaCe_{0.7}Zr_{0.1}Y_{0.1}Yb_{0.1}O_{3-δ},) as a proton-conducting solid oxide electrolyte. The proton-conducting solid oxide electrolyzer was operated at an oxygen concentration of about 20% by volume.

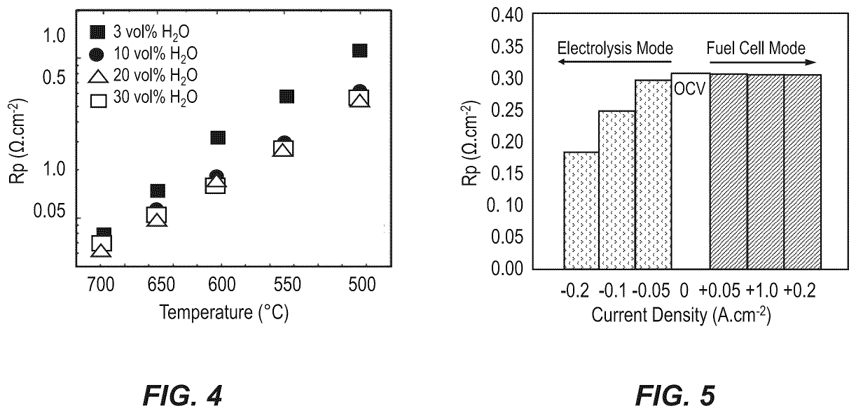

FIG. 4 is a graphical result showing the polarization resistances (Rₚ) (in Ω·cm⁻²) of the proton-conducting solid oxide electrolyzer as a function of temperature at different steam concentrations (in % vol). Four concentrations of the steam (H₂O) were tested (3 vol %, 10 vol %, 20 vol %, and 30 vol %), each at five different operating temperatures (700° C., 650° C., 600° C., 550° C., and 500° C.).

As shown in FIG. 4, an increase in the steam concentration while maintaining the same oxygen concentration (e.g., at 20% by volume of oxygen gas) resulted in a reduction of the polarization resistances (Rₚ) of the proton-conducting solid oxide electrolyzer. Such a phenomenon was even more prominent at the operating temperatures below 600° C. The results showed an enhanced electrochemical activity of proton-conducting solid oxide electrolyzer as the concentrations of steam increased.

To study the effect of electrical bias on the proton-conducting solid oxide electrolyzer under electrolysis and fuel cell operating conditions, three-electrode measurements were further conducted.

FIG. 5 is a graphical result showing the polarization resistances (Rₚ) (in Ω·cm⁻²) of the three-electrode cell as a function of current density (in A·cm⁻²) when the cell was operated in an electrolysis mode (e.g., as a proton-conducting solid oxide electrolyzer), and in a fuel cell mode (e.g., as a proton-conducting solid oxide fuel cell).

As shown in FIG. 5, an increase in the electrolysis current density dramatically decreased the Rₚ, indicating an improved activity of the proton-conducting solid oxide electrolysis cell (P-SOEC) utilizing BCZZ #1 electrode material in the electrolysis mode. On the other hand, the Rₚ of the P-SOEC utilizing BCZZ #1 electrode material showed minimal variation in the fuel cell mode.

### Example 9

The Faraday efficiency of the proton-conducting solid oxide electrolyzer utilizing BCZZ #1 electrode material was investigated at different operation conditions. The studied operating conditions included the steam concentration, the electrolysis current density, the cell voltage, and the operating temperature.

The Faraday efficiency of the proton-conducting solid oxide electrolyzer was measured under the same gas atmosphere (i.e., air with steam fed to the anode, pure dry hydrogen fed to the cathode).

The proton-conducting solid oxide electrolyzer used in the study was an 1-inch proton-conducting solid oxide electrolyzer utilizing an electrode configured to produce oxygen gas from steam (“an anode”) containing a composite of BCZZ #1 (BaCo_{0.8}Zr_{0.1}Zn_{0.1}O_{3-δ}) and BZCYYb (BaZr_{0.1}Ce_{0.7}Y_{0.1}Yb_{0.1}O_{3-δ}), an electrode configured to produce hydrogen gas from the steam (“a cathode”) containing Ni—BZCYYb (Ni—BaCe_{0.7}Zr_{0.1}Y_{0.1}Yb_{0.1}O₃), and a proton-conducting solid oxide electrolyte containing BZCYYb (BaZr_{0.1}Ce_{0.7}Y_{0.1}Yb_{0.1}O_{3-δ}) as the electrolyte at a thickness of 10 μm.

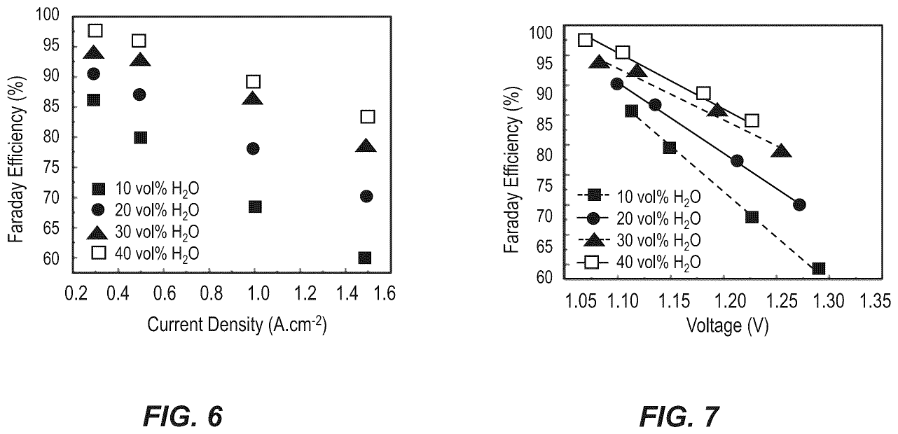

FIG. 6 is a graphical result showing the Faraday efficiency (in %) as a function of the current density (in A·cm⁻²) applied to the 1-inch proton-conducting solid oxide electrolyzer at an operating temperature of about 600° C. and at different steam concentrations (in vol %). FIG. 7 is a graphical result showing the Faraday efficiency (in %) as a function of the cell voltage (in V) applied to the 1-inch proton-conducting solid oxide electrolyzer at an operating temperature of about 600° C. and at different steam concentrations (in vol %).

As shown in FIGS. 6 and 7, at the same current density or cell voltage, an increase in the steam concentration led to an increase in the Faraday efficiency. This was because the high concentration of steam suppresses the p-type electronic leakage in the BZCYYb electrolyte. At the same steam concentration, an increase in the current density or cell voltage led to a decrease in the Faraday efficiency.

Furthermore, FIG. 6 showed that when the 1-inch proton-conducting solid oxide electrolyzer was operated at a temperature of about 600° C. and at about 30 vol % H₂O, the Faraday efficiency of about 86.56% was achieved at the electrolysis current density of about 1 A·cm⁻². A further increase in the steam concentration to 40 vol % only slightly increased the Faraday efficiency to about 89.37% at the same condition, with a sacrifice of the potential accelerated degradation of the 1-inch PECE during long-term operations.

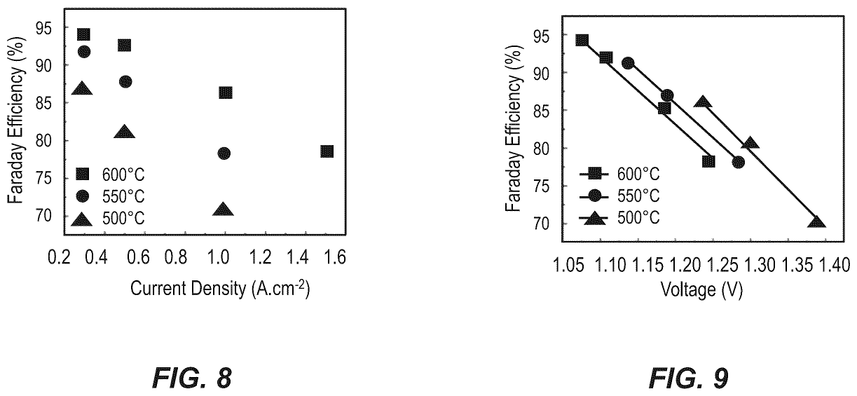

FIG. 8 is a graphical result showing the Faraday efficiency (in %) of the 1-inch proton-conducting solid oxide electrolyzer as a function of the operating temperature (in ° C.) at a steam concentration of 30 vol % and at different current density (in A·cm⁻²) applied to the 1-inch proton-conducting solid oxide electrolyzer. At the same current density, a reduction in the operation temperature led to a decrease in the Faraday efficiency.

FIG. 9 is a graphical result showing the Faraday efficiency (in %) of the 1-inch proton-conducting solid oxide electrolyzer as a function of the operating temperature (in ° C.) and the cell voltage (in V) applied to the 1-inch proton-conducting solid oxide electrolyzer at a steam concentration of 30 vol %. At the same cell voltage, a reduction in the operating temperature led to an increases in the Faraday efficiency. This was due to the higher ionic transference number and lower electronic leakage of proton-conducting solid oxide electrolyte at lower temperatures.

### Example 10

The effect of the proton-conducting electrolyte material on the Faraday efficiency of the proton-conducting solid oxide electrolyzer was investigated at different operating conditions.

The 1-inch proton-conducting solid oxide electrolyzer used in the study was composed of an electrode configured to produce oxygen gas from steam (“an anode”) containing BCZZ #1 (BaCo_{0.8}Zr_{0.1}Zn_{0.1}O_{3-δ}), an electrode configured to produce hydrogen gas from the steam (“a cathode”) containing Ni—BZCYYb (Ni—BaCe_{0.7}Zr_{0.1}Y_{0.1}Yb_{0.1}O₃), and the tested proton-conducting solid oxide electrolyte at a thickness of about 10 μm. The 1-inch proton-conducting solid oxide electrolyzer was operated at a steam concentration of 30 vol % H₂O. Two types of the proton-conducting solid oxide electrolytes used in the study were BaZr_{0.1}Ce_{0.7}Y_{0.1}Yb_{0.1}O_{3-δ} (“Elec #1”) and BaZr_{0.4}Ce_{0.4}Y_{0.1}Yb_{0.1}O_{3-δ} (“Elec #2”).

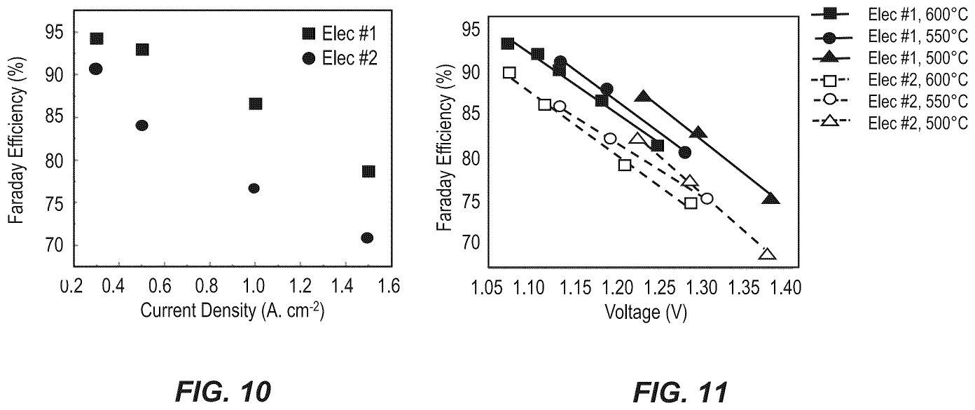

FIG. 10 is graphical result showing the Faraday efficiency (in %) of the 1-inch proton-conducting solid oxide electrolyzer as a function of electrolysis current density (in A·cm⁻²) applied to the 1-inch proton-conducting solid oxide electrolyzer at an operating temperature of about 600° C. Elect #1 provided the 1-inch proton-conducting solid oxide electrolyzer with a relatively higher Faraday efficiency compared to Elect #2, especially with an increase in the current density applied to the 1-inch proton-conducting solid oxide electrolyzer. Elect #1 had a higher Ce content (based on atomic weight) compared to Elect #2. Thus, the proton-conducting solid oxide electrolyte with a higher Ce content provided a higher ionic transference number and a higher initial faraday efficiency compared to the proton-conducting solid oxide electrolyte with a lower Ce content.

### Example 11

The effect of the proton-conducting solid oxide electrolyte material and the thickness thereof on the Faraday efficiency of the proton-conducting solid oxide electrolyzer (PCE) at different operation conditions was determined.

The 1-inch proton-conducting solid oxide electrolyzer used in the study was composed of an electrode configured to produce oxygen gas from steam (“an anode”) containing BCZZ #1 (BaCo_{0.8}Zr_{0.1}Zn_{0.1}O_{3-δ}), an electrode configured to produce hydrogen gas from the steam (“a cathode”) containing Ni—BZCYYb (Ni—BaCe_{0.7}Zr_{0.1}Y_{0.1}Yb_{0.1}O₃), and the tested proton-conducting solid oxide electrolyte at a thickness of about 10 μm. Two types of the proton-conducting solid oxide electrolyte used in the study were BaZr_{0.1}Ce_{0.7}Y_{0.1}Yb_{0.1}O_{3-δ} (“Elec #1”) and BaZr_{0.4}Ce_{0.4}Y_{0.1}Yb_{0.1}O_{3-δ} (“Elec #2”).

The 1-inch proton-conducting solid oxide electrolyzer was operated at a steam concentration of 30 vol % H₂O, and at different tested operation temperatures (600° C., 550° C., and 550° C.).

FIG. 11 is graphical result showing the Faraday efficiency (in %) of the 1-inch proton-conducting solid oxide electrolyzer as a function of cell voltage (in V) applied to the 1-inch proton-conducting solid oxide electrolyzer at three different operating temperatures (in ° C.). For the Elect #1, the Faraday efficiency of the 1-inch proton-conducting solid oxide electrolyzer decreased as the voltage of the 1-inch proton-conducting solid oxide electrolyzer increased. Furthermore, the Faraday efficiency of the 1-inch proton-conducting solid oxide electrolyzer increased as the operation temperature of the 1-inch proton-conducting solid oxide electrolyzer decreased.

Similarly, for the Elect #2, the Faraday efficiency of the 1-inch proton-conducting solid oxide electrolyzer decreased as the voltage of the 1-inch proton-conducting solid oxide electrolyzer increased. Furthermore, the Faraday efficiency of the 1-inch proton-conducting solid oxide electrolyzer increased as the operation temperature of the 1-inch proton-conducting solid oxide electrolyzer decrease.

FIG. 11 also confirmed the results of FIG. 10 that the proton-conducting solid oxide electrolyte with a higher Ce content (e.g., BaZr_{0.1}Ce_{0.7}Y_{0.1}Yb_{0.1}O_{3-δ}) provided a higher ionic transference number and a higher initial Faraday efficiency compared to the proton-conducting solid oxide electrolyte with a lower Ce content (e.g., BaZr_{0.4}Ce_{0.4}Y_{0.1}Yb_{0.1}O_{3-δ}).

### Example 12

The effect of the thickness of the proton-conducting solid oxide electrolyte on the Faraday efficiency of the proton-conducting solid oxide electrolyzer was studied at different operating conditions.

The 1-inch proton-conducting solid oxide electrolyzer used in the study was composed of an electrode configured to produce oxygen gas from steam (“an anode”) containing BCZZ #1 (BaCo_{0.8}Zr_{0.1}Zn_{0.1}O_{3-δ}), an electrode configured to produce hydrogen gas from the steam (“a cathode”) containing Ni—BZCYYb (Ni—BaCe_{0.7}Zr_{0.1}Y_{0.1}Yb_{0.1}O₃), and a proton-conducting solid oxide electrolyte BaZr_{0.1}Ce_{0.7}Y_{0.1}Yb_{0.1}O_{3-δ}. Three (3) different thickness of the proton-conducting solid oxide electrolyte were tested (6 μm, 10 μm, and 18 μm). Each of the 1-inch proton-conducting solid oxide electrolyzers was operated at a steam concentration of 30 vol % H₂O, and at three different tested operation temperatures (600° C., 550° C., and 550° C.).

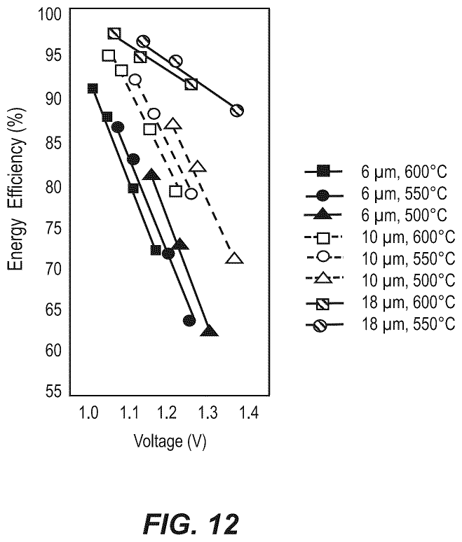

FIG. 12 is graphical result showing the Faraday efficiency (in %) of the proton-conducting solid oxide electrolyzer as a function of cell voltage (in V) applied to the proton-conducting solid oxide electrolyzer at different operating temperatures, and at different thickness (in μm) of the proton-conducting solid oxide electrolyte. FIG. 12 showed that as the voltage of the 1-inch proton-conducting solid oxide electrolyzer was increased, the energy efficiency decreased. The effect of the cell voltage on the Faraday efficiency appeared to be less prominent in the 1-inch proton-conducting solid oxide electrolyzer utilizing the electrolyte at a relatively higher thickness. At the same thickness of the proton-conducting solid oxide electrolyte, the higher Faraday efficiency was achieved when the 1-inch proton-conducting solid oxide electrolyzer was operated at a relatively lower temperature.

### Example 13

The effect of the energy efficiency on the hydrogen gas production of the proton-conducting solid oxide electrolyzer was investigated.

The 1-inch proton-conducting solid oxide electrolyzer used in the study was composed of an electrode configured to produce oxygen gas from steam (“an anode”) containing BCZZ #1 (BaCo_{0.8}Zr_{0.1}Zn_{0.1}O_{3-δ}), an electrode configured to produce hydrogen gas from the steam (“a cathode”) containing Ni—BZCYYb (Ni—BaCe_{0.7}Zr_{0.1}Y_{0.1}Yb_{0.1}O₃), and a proton-conducting solid oxide electrolyte BaZr_{0.1}Ce_{0.7}Y_{0.1}Yb_{0.1}O_{3-δ}. Three different thickness of the proton-conducting solid oxide electrolyte were tested (6 μm, 10 μm, and 18 μm).

The 1-inch proton-conducting solid oxide electrolyzer was operated at a steam concentration of 30 vol % H₂O, and at three different tested operation temperatures (600° C., 550° C., and 550° C.).

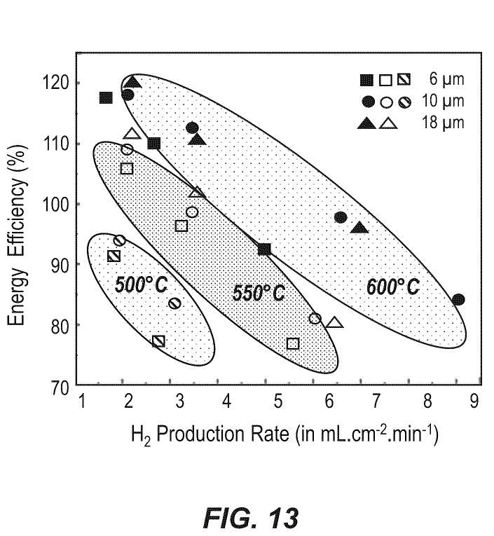

FIG. 13 is a graphical result showing the energy efficiency (in %) as a function of the H₂ production rate (in mL·cm⁻²·min⁻¹) of the 1-inch proton-conducting solid oxide electrolyzer with different electrolyte thickness and at three different operating temperatures.

As shown in FIG. 13, at the same operation temperature, the 1-inch proton-conducting solid oxide electrolyzer with a thicker electrolyte showed a higher energy efficiency at the same hydrogen production rate. A reduction in the operating temperature generally decreased the energy efficiency at the same hydrogen production rate.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

What is claimed is:

1. A proton-conducting solid oxide electrolyzer, comprising:
a first electrode configured to produce oxygen gas from steam, the first electrode comprising a barium zirconate of formula BaZrO_{3-δ} doped with at least one transition metal and substantially free of a rare earth element, wherein δ is an oxygen deficit, and wherein the at least one transition metal comprises cobalt;
a second electrode configured to produce hydrogen gas from the steam; and
a proton-conducting solid oxide electrolyte between the first electrode and the second electrode.

2. The proton-conducting solid oxide electrolyzer of claim 1, wherein the at least one transition metal of the barium zirconate of formula BaZrO_{3-δ} of the first electrode further comprises zinc.

3. The proton-conducting solid oxide electrolyzer of claim 1, wherein the barium zirconate of formula BaZrO_{3-δ} doped with the at least one transition metal comprises BaCo_{0.8}Zr_{0.1}Zn_{0.1}O_{3-δ}, BaCo_{0.7}Zr_{0.2}Zn_{0.1}O_{3-δ}, BaCo_{0.7}Zr_{0.1}Zn_{0.2}O_{3-δ}, or any combination thereof, wherein δ is an oxygen deficit.

4. The proton-conducting solid oxide electrolyzer of claim 1, wherein the proton-conducting solid oxide electrolyte comprises a perovskite having an ionic conductivity greater than or equal to about 10⁻² S/cm at one or more temperatures within a range of from about 400° C. to about 700° C.

5. The proton-conducting solid oxide electrolyzer of claim 1, wherein the proton-conducting solid oxide electrolyte comprises a yttrium- and ytterbium-doped barium-cerate-zirconate (BCZYYb), a yttrium- and ytterbium-doped barium-strontium-niobate (BSNYYb), a doped barium-cerate, a doped barium-zirconate, a barium-yttrium-stannate, a barium-calcium-niobate, or any combination thereof.

6. The proton-conducting solid oxide electrolyzer of claim 1, wherein the proton-conducting solid oxide electrolyte comprises yttrium- and ytterbium-doped barium-cerate-zirconate (BCZYYb).

7. The proton-conducting solid oxide electrolyzer of claim 1, wherein the proton-conducting solid oxide electrolyte comprises BaCe_{0.4}Zr_{0.4}Y_{0.1}Yb_{0.1}O_{3-δ}, BaCe_{0.5}Zr_{0.3}Y_{0.1}Yb_{0.1}O_{3-δ}, BaCe_{0.7}Zr_{0.1}Y_{0.1}Yb_{0.1}O_{3-δ}, or any combination thereof, wherein δ is an oxygen deficit.

8. The proton-conducting solid oxide electrolyzer of claim 1, wherein the proton-conducting solid oxide electrolyte has a thickness of from about 6 microns (μm) to about 18 μm.

9. The proton-conducting solid oxide electrolyzer of claim 1, wherein the second electrode comprises a cermet material including at least one metal and at least one perovskite.

10. The proton-conducting solid oxide electrolyzer of claim 9, wherein the at least one perovskite of the cermet material of the second electrode comprises a yttrium- and ytterbium-doped barium-cerate-zirconate (BCZYYb), a yttrium- and ytterbium-doped barium-strontium-niobate (BSNYYb), a doped barium-zirconate, a doped barium-cerate, doped barium zirconate-cerate, a barium-yttrium-stannate, a barium-calcium-niobate, or any combination thereof.

11. The proton-conducting solid oxide electrolyzer of claim 10, wherein the second electrode comprises a cermet material including Ni—BCZYYb.

12. The proton-conducting solid oxide electrolyzer of claim 1, wherein the proton-conducting solid oxide electrolyzer exhibits a current density of about 1.98 A cm⁻² at a cell voltage of about 1.3 V and an operating temperature of about 600° C.

13. An electrode for a proton-conducting solid oxide electrolyzer, comprising a barium zirconate of formula BaZrO_{3-δ} doped with at least one transition metal and substantially free of a rare earth element, wherein:
δ is an oxygen deficit, and
the at least one transition metal comprises cobalt (Co), iron (Fe), nickel (Ni), copper (Cu), zinc (Zn), manganese (Mn), chromium (Cr), niobium (Nb), molybdenum (Mo), titanium (Ti), vanadium (V), or any combination thereof.

14. The electrode of claim 13, wherein the barium zirconate of formula BaZrO_{3-δ} doped with at least one transition metal exhibits a perovskite structure.

15. The electrode of claim 13, wherein the barium zirconate of formula BaZrO_{3-δ} doped with at least one transition metal comprises BaCo_{0.8}Zr_{0.1}Zn_{0.1}O_{3-δ}.

16. The electrode of claim 13, further comprising yttrium- and ytterbium-doped barium-cerate-zirconate (BCZYYb).

17. A method of producing hydrogen gas, comprising:
introducing steam into a proton-conducting solid oxide electrolyzer comprising:
a first electrode formulated to produce oxygen gas from the steam, and comprising barium zirconate of formula BaZrO_{3-δ} doped with at least one transition metal and substantially free of a rare earth element, wherein δ is an oxygen deficit, and wherein the at least one transition metal comprises cobalt;
a second electrode formulated to produce hydrogen gas from the steam; and
a proton-conducting solid oxide electrolyte between the first electrode and the second electrode; and
applying a potential difference between the first electrode and the second electrode of the proton-conducting solid oxide electrolyzer to produce the hydrogen gas from the steam.

18. The method of claim 17, wherein applying the potential difference between the first electrode and the second electrode of the proton-conducting solid oxide electrolyzer comprises applying the potential difference at a temperature within a range of from about 400° C. to about 600° C.

19. The method of claim 17, wherein applying the potential difference between the first electrode and the second electrode of the proton-conducting solid oxide electrolyzer comprises applying a potential voltage of from about 1.0 volts (V) to about 1.5 V between the first electrode and the second electrode of the proton-conducting solid oxide electrolyzer.

20. The method of claim 17, wherein introducing the steam into the proton-conducting solid oxide electrolyzer comprises feeding the steam into the proton-conducting solid oxide electrolyzer comprising the second electrode including a nickel/perovskite cermet.
